(19) United States
(12) Patent Application Publication
(10) Pub. No.: US 2004/0186745 A1
(43) Pub. Date: Sep. 23, 2004

(54) Medical network sever and medical network system

(75) Inventor: Takeshi Funahashi, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO, LTD.

(21) Appl. No.: 10/802,864

(22) Filed: Mar. 18, 2004

(30) Foreign Application Priority Data
Mar. 19, 2003 (JP) 2003-076471

(51) Int. Cl. G06F 17/60

(52) U.S. Cl. 705/2

(57) ABSTRACT

A medical network server for receiving and transmitting information on electric medical charts from/to a plurality of medical institutions through a communication network. The medical network server includes: a patient information storage section storing thereon the information on the electric medical charts including medical records of a plurality of patients diagnosed by a physician at each of the plurality of medical institutions, and location information indicating location of each of the medical institutions or addresses of patients; an incidence rate computing section for computing incidence rate of a disease in each area based on the medical records and the location information of the plurality of patients; a spread area identification section for identifying a first area, where the disease spreads, based on the incidence rate computed by said incidence rate computing section; and a spread area forecast section for forecasting a second area, related to the first area with respect to the spread of the disease and in which the disease is supposed to spread in the future, based on a relationship between the first area and the second area. The incidence rate of a disease in each area can be computed, and the area where the disease will spread in the future is forecasted based on the electric medical charts.

This patent application claims priority from a Japanese patent application No. 2003-076471 filed on Mar. 19, 2003, the contents of which are incorporated herein by reference.

### BACKGROUND OF THE INVENTION

1. Field of the Invention

The present invention relates to a medical network server and medical network system. More particularly, the present invention relates to a medical network server and a medical network system for receiving and distributing information on electric medical charts from/to a plurality of medical institutions through a communication network.

2. Description of the Related Art

With the developments in computer application, paper-based medical charts are being replaced with electronic medical charts using computer application to promote rationalization and efficiency of medical service in medical institutions. Moreover, it is proposed a system for storing electronic medical charts on a share server accessible from a plurality of medical institutions, and the plurality of medical institutions access and share medical records on the electronic medical charts. (Cf. “Nikkei NetBusiness”, Sep. 25, 2002, pp. 66-71)

However, according to the above-described system, though the electronic medical charts is transmitted and received among the plurality of medical institutions, the information on the electronic medical charts has not been utilized so effectively. Therefore, what remains to be done is to utilize the information on the electronic medical charts received from the plurality of medical institutions more effectively.

### SUMMARY OF THE INVENTION

Therefore, it is an object of the present invention to provide a medical network server and a medical network system which can solve the foregoing problems. The above and other objects can be achieved described in the independent claims. The dependent claims define further advantageous and exemplary combinations of the present invention.

According to a first aspect of the present invention, there is provided a medical network server for receiving and transmitting information on electric medical charts from/to a plurality of medical institutions through a communication network. The medical network server includes: a patient information storage section storing thereon the information on the electric medical charts including medical records of a plurality of patients diagnosed by a physician at each of the plurality of medical institutions, and location information indicating location of each of the medical institutions or addresses of patients; an incidence rate computing section for computing incidence rate of a disease in each area based on the medical records and the location information of the plurality of patients; a spread area identification section for identifying a first area, where the disease spreads, based on the incidence rate computed by the incidence rate computing section; and a spread area forecast section for forecasting a second area, related to the first area with respect to the spread of the disease and in which the disease is supposed to spread in the future, based on a relationship between the first area and the second area.

The spread area forecast section may forecast the second area based on outbreak history information including the incidence rate of the disease in each of the areas during a plurality of time periods in the past.

The spread area forecast section may forecast the second area based on frequency of traffic between the first area and the second area.

The medical network server may further include an outbreak forecast information storage section storing thereon the outbreak forecast information, and the spread area forecast section may forecast the second area based on the outbreak forecast information stored on the outbreak forecast information storage section.

The spread area forecast section may further forecast a time period when the disease will spread in the second area in the future based on the outbreak history information.

The medical network server may further include a warning section for issuing warning to the medical institution located in the second area forecasted by the spread area forecast section in order to prompt the medical institution located in the second area forecasted by the spread area forecast section to prepare for the spread of the disease in the future.

The medical network server may further include a medical device indicating section for indicating medical devices required by the medical institution for diagnosis and treatment of the disease to the medical institution.

The medical device indicating section may further indicate quantity of the medical devices required by the medical institution for diagnosis and treatment of the disease to the medical institutions based on the incidence rate computed by the incidence rate computing section.

According to a second aspect of the present invention, there is provided a medical network system for relaying information on electric medical charts through a communication network. The medical network system includes: a plurality of medical institutions storing therein the electric medical charts; and a medical network server for receiving and transmitting the information on the electric medical charts from/to the plurality of medical institutions through the communication network. The medical network server includes: a patient information storage section storing thereon the information on the electric medical charts including medical records of a plurality of patients diagnosed by a physician at each of the plurality of medical institutions, and location information indicating location of each of the medical institutions or addresses of patients; an incidence rate computing section for computing incidence rate of a disease in each area based on the medical records and the location information of the plurality of patients; a spread area identification section for identifying a first area, where the disease spreads, based on the incidence rate computed by the incidence rate computing section; and a spread area forecast section for forecasting a second area, related to the first area with respect to the spread of the disease and in which the disease is supposed to spread in the future, based on a relationship between the first area and the second area.

According to a third aspect of the present invention, there is provided a method of receiving and transmitting information on electric medical charts from/to a plurality of medical institutions through a communication network. The method includes steps of: storing information on the electric medical charts including medical records of a plurality of patients diagnosed by a physician at each of the plurality of medical institutions, and location information indicating location of each of the medical institutions or addresses of patients; computing incidence rate of a disease in each area based on the medical records and the location information of the plurality of patients; identifying a first area, where the disease spreads, based on the incidence rate computed in the incidence rate computing step; and forecasting a second area, related to the first area with respect to the spread of the disease and in which the disease is supposed to spread in the future, based on a relationship between the first area and the second area.

According to a fourth aspect of the present invention, there is provided a computer readable medium storing thereon a program for causing a medical network server to receive and transmit information on electric medical charts from/to a plurality of medical institutions through a communication network. The program including modules configured to execute steps of: storing information on the electric medical charts including medical records of a plurality of patients diagnosed by a physician at each of the plurality of medical institutions, and location information indicating location of each of the medical institutions or addresses of patients; computing incidence rate of a disease in each area based on the medical records and the location information of the plurality of patients; identifying a first area, where the disease spreads, based on the incidence rate computed in the incidence rate computing step; and forecasting a second area, related to the first area with respect to the spread of the disease and in which the disease is supposed to spread in the future, based on a relationship between the first area and the second area.

The summary of the invention does not necessarily describe all necessary features of the present invention. The present invention may also be a sub-combination of the features described above.

### BRIEF DESCRIPTION OF THE DRAWINGS

FIG. 1 is schematic view exemplary showing a configuration of a medical network system.

FIG. 2 is a block diagram exemplary showing a configuration of a medical network server.

FIG. 3 is a drawing exemplary showing a data structure of data stored on a patient information storage section.

FIG. 4 is a table exemplary showing a data structure of data on an outbreak history storage section.

### DETAILED DESCRIPTION OF THE INVENTION

The invention will now be described based on the preferred embodiments, which do not intend to limit the scope of the present invention, but exemplify the invention. All of the features and the combinations thereof described in the embodiment are not necessarily essential to the invention.

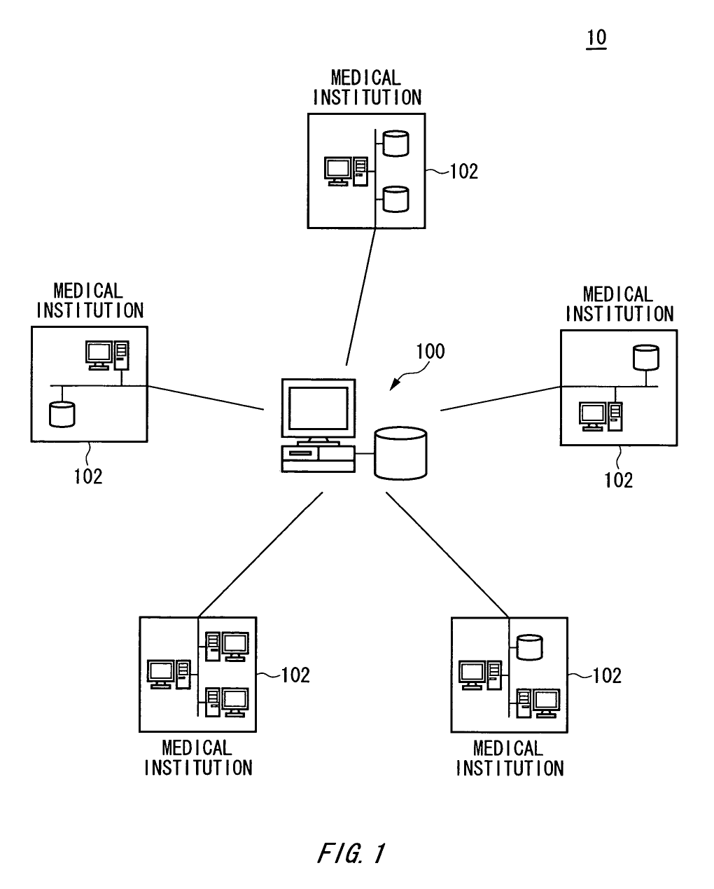

FIG. 1 is a schematic view exemplary showing a configuration of a medical network system 10 according to an embodiment of the present invention. The medical network system 10 collects information on electronic medical charts of patients from hospitals, pharmacies, health centers, etc., located nationwide and/or worldwide for identifying an area infected with communicable disease like influenza, and forecasting an infection route. Then, a warning is issued to hospitals, pharmacies, health centers, etc. located in the area where the communicable disease may spread in the future so that the hospitals, the pharmacies, the health centers, will be ready to deal with the communicable disease.

The medical network system 10 includes a medical network server 100 and a plurality of medical institutions 102. The medical network server 100 is connected to each local area network in the plurality of medical institutions 102 through a communication network, such as the Internet. Each of the plurality of medical institutions 102 stores the information on the electronic medical charts, which includes diagnostic information and treatment information on the patients of the medical institution, on a server or a data base connected to the LAN in the medical institution. The medical network server 100 receives and stores the information on the electronic medical charts from the plurality of medical institutions 102 through the communication network. Moreover, the medical network server 100 provides the information on the medical charts received from the plurality of medical institutions 102 to each of the plurality of medical institutions on request.

The medical network server 100 computes an incidence rate of a disease in each area based on the information on the electric medical charts received from the plurality of medical institutions 102. Then, the area where the disease is spreading (to be referred to as “first area” hereinafter) is identified. Moreover, the medical network server 100 forecasts the incidence rate of the disease in each area in the future. For example, incidence rate of the disease in each area in the future is forecasted based on the incidence rate of the disease in each area in the past. Alternatively, it is possible to take into consideration a traffic system, e.g., a railroad system, a road system, etc., movement of patients, e.g., change of residence, tourism, business trip, etc., and the like.

Moreover, the medical network server 100 issues warning to the medical institution 102 in an area where the disease may spread in the future (to be referred to as “second area” hereinafter). Moreover, medical devices, such as X-ray films, treatment equipment, diagnostic tools, medicines, etc., which may be required in the future to deal with the disease will be indicated with the warning. Accordingly, since the medical institution 102 can replenish the stock of the medical devices before the disease spreads, the medical institution 102 is prepared promptly for the increase in number of the patients infected with the disease in the future.

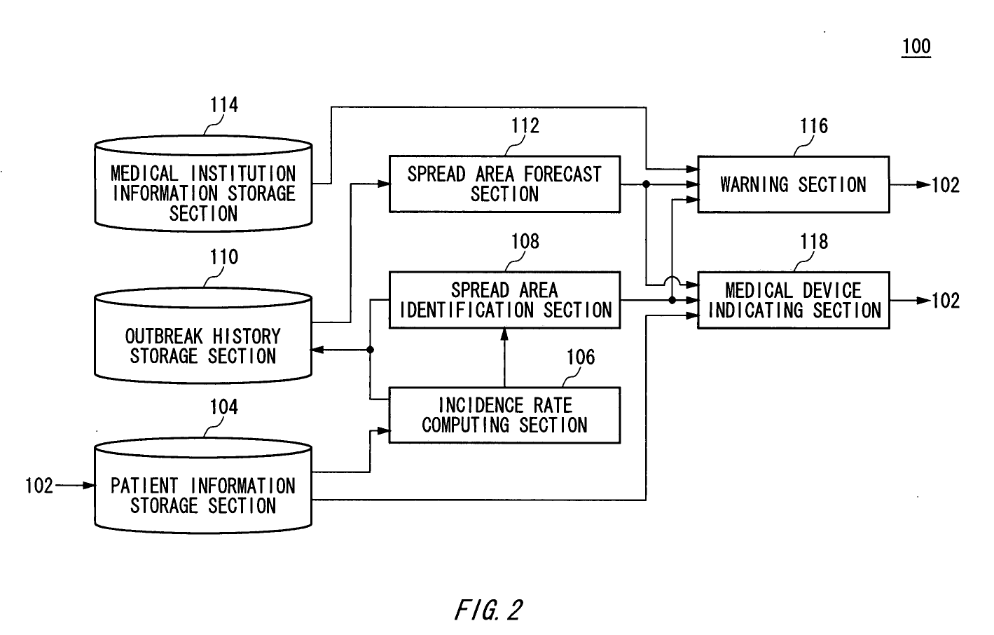

FIG. 2 is a block diagram exemplary showing a configuration of the medical network server 100 according to the present embodiment. The medical network server 100 includes: a patient information storage section 104 storing thereon information on medical charts including medical records of patients recorded by a physician of each of the plurality of medical institutions 102 and location information on the patients; an incidence rate computing section 106 for computing an incidence rate of the disease in each area based on the medical records of the plurality of patients and the location information on the patients; and a spread area identification section 108 for identifying the first area based on the incidence rate computed by the incidence rate computing section 106. For example, the location information on the patients is information indicating the location of the medical institution which the patients attend, or information indicating addresses of the patients.

The incidence rate computing section 106 totals the number of patients infected with the disease during a predetermined time period in each area referring to the information on the electric medical charts stored on the patient information storage section 104. Then, the incidence rate computing section 106 obtains the incidence rate of the disease in a certain area by dividing the number of patients infected with the disease in the area by the number of the electric medical charts of the patient in the area. Alternatively, the incidence rate computing section 106 obtains the incidence rate of the disease in the area by dividing the number of patients infected with the disease in the area by the average of the number of the patients who had been infected with the disease in the area during a predetermined time period in the past. Alternatively, the incidence rate computing section 106 computes incidence rates in each age and/or gender bracket.

Moreover, the medical network server 100 further includes: an outbreak history storage section 110 storing thereon outbreak history information including the incidence rate of the diseases in each area during a plurality of time periods in the past computed by the incidence rate computing section 106; and a spread area forecast section 112 for forecasting an area where the disease will spread in the future (second area) and/or a time period when the disease will spread in the area in the future. For example, the spread area forecast section 112 forecasts the area where the disease will spread in the future and a time period when the disease will spread in the area in the future based on the outbreak history information stored on the outbreak history storage section 110.

In the present embodiment, the outbreak history storage section 110 is an example of outbreak forecast information of the present invention, and the outbreak history information is an example of outbreak forecast information of the present invention.

Alternatively, the spread area forecast section 112 forecasts the second area based on frequency of traffic between the first area and the second area.

For example, the spread area forecast section 112 selects the second area where the people in the first area infected with the disease moves frequently, and simulates how the disease will spread between the first area and the second area. For example, when the first area and the second area are connected with a trunk line, and when the first area and the second area adjoin, it simulates that the probability of the people moving between the first area and the second area is high.

Moreover, the medical network server 100 further includes: a medical institution information storage section 114 storing thereon access information to the medical institutions 102; a warning section 116 for issuing warning to the medical institution 102 in the area identified by the spread area identification section 108 and forecasted by the spread area forecast section 112, to prompt the medical institution 102 to prepare for spread of the disease; and a medical device indicating section 118 for indicating the medical devices required for diagnosis and treatment of the disease to the medical institution 102.

For example, the medical institution information storage section 114 stores mail address of the medical institutions 102 in association with the areas where the medical institutions 102 are located, respectively. Then, the warning section 116 sends an e-mail to the medical institution 102 in the area identified by the spread area identification section 108 and the spread area forecast section 112 using the mail address stored on the medical institution information storage section in association with the area where the medical institution 102 is located to warn that the disease may spread.

Moreover, the medical device indicating section 118 further indicates the quantity of the medical devices required bathe medical institution 102 for the diagnosis and the treatment of the disease to the medical institution 102 based on the incidence rate computed by the incidence rate computing section 106. Alternatively, the medical device indicating section 118 forecasts the required quantity of the medical devices according to the scale of the medical institution 102, and indicates the required quantity of the medical devices to the medical institution 102. Alternatively, the medical device indicating section 118 attaches the information indicating the required medical devices and the required quantity of the medical devices to the e-mail, which is to be sent to the medical institution 102 by the warning section 116.

Alternatively, the medical network server 100 issues the warning to the medical institution 102 in an area neighboring the second area (to be referred to as “neighboring area” hereinafter), so that the medical institution 102 in the neighboring area can aid the medical institution 102 in the area infected with the disease in the future (to be referred to as “infected area” hereinafter). Moreover, medical devices, such as X-ray films, treatment equipment, diagnostic tools, medicines, etc., which may be required in the future in the medical institution 102 in the infected area to deal with the disease will be indicated with the warning. Accordingly, since the medical institution 102 in the neighboring area can replenish the stock of the medical devices before the disease spreads in the infected area, the medical institution 102 in the neighboring area is prepared promptly for the increase in number of the patients infected with the disease in the infected area in the future, and will be ready to aid the infected area.

In this case, the warning section 116 sends an e-mail to the medical institution 102 in the neighboring area using the mail address stored on the medical institution information storage section in association with the neighboring area to ask the medical institution 102 in the neighboring area to aid the medical institution 102 in the infected area.

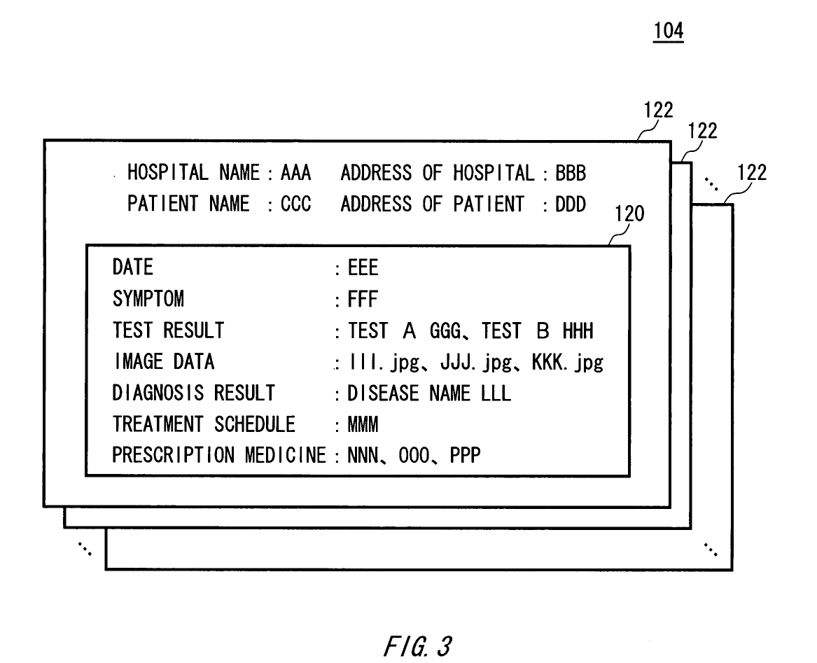

FIG. 3 is a drawing exemplary showing a data structure of data stored on the patient information storage section 104 according to the present embodiment. The patient information storage section 104 stores information on a plurality of electric medical charts 122 of a plurality of patients, each of which includes identification information on the medical institution, such as name of the medical institution, information indicating a location of the medical institution, identification information on the patients, such as name of the patient, information indicating an address of the patient, and medical information 120. For example, the medical information 120 includes a date of diagnosis, a symptom of the patient, result of a medical test, image data such as radiographic image data, diagnosis result such as a disease name, a treatment schedule, and a prescription medicine.

When forecasting the medical devices required by the medical institution 102 for the diagnosis and the treatment of the disease, the medical device indicating section 118 refers to the information on the plurality of electric medical charts 122 stored on the patient information storage section 104. Specifically, the medical device indicating section 118 acquires information on medical examinations provided by a physician such as what kind of test was done and how many times the test was done, what kind of radiograph was taken and how many times the radiograph was taken, how the treatment plan was developed, how the medicine was prescribed, and the like. Then, the medical device indicating section 118 forecasts the medical devices required by the medical institution 102 for the diagnosis and the treatment of the disease and the quantity of the medical devices, and indicates the forecast result to the medical institution 102.

In this way, reliable information can be obtained by forecasting the medical devices and the quantity of the medical devices required by the medical institution 102 in the future by referring to the information on the diagnosis, treatment, and prescription which were provided by the physician. Therefore, the medical institution 102 can deal with the disease promptly according to the information from the medical network server 100.

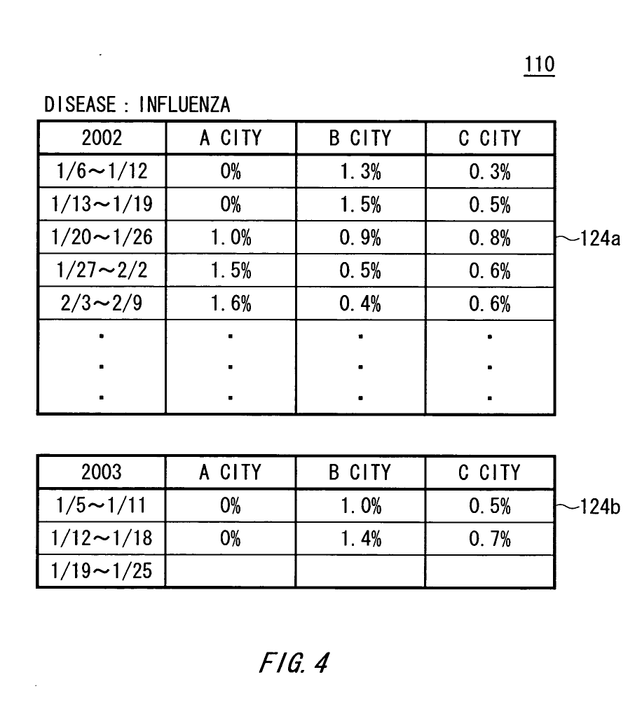

FIG. 4 is a table exemplary showing a data structure of data on the outbreak history storage section 110 according to the present embodiment. The outbreak history storage section 110 stores outbreak history information 124a and 124b including the incidence rates of the disease in each area during a plurality of time periods in the past. In the example depicted in FIG. 4, the incidence rates of influenza in an A city, a B city and a C city for each week in the years 2002 and 2003 is recorded. In addition, each of the incidence rates (%) depicted in FIG. 4 indicates the percentage of the number of the patients infected with influenza in a predetermined area on the total number of the electric medical charts of the patients in the predetermined area. For example, the percentage of the number of the patients infected with influenza in the A city on the total number of the electric medical charts of the patients who reside in the A city is indicated.

The spread area forecast section 112 forecasts the area where influenza will spread in the future with reference to the outbreak history information 124a and 124b stored on the outbreak history storage section 110. As an example, how to forecast the incidence rate of influenza from 19 Jan. 2003 to 25 Jan. 2003 will be explained hereinafter. When the outbreak history information 124a in the year 2002 is referred to, the incidence rate of influenza in the A city increased after the incidence rate of influenza in the B city had increased. Therefore, it can be forecasted that the incidence rate of influenza will increase from 19 Jan. 2003 to 25 Jan. 2003 in the A city judging from the increase and decrease of the incidence rates of influenza in the A city and the B city in the year 2003 stored on the outbreak history information 124b.

The medical network server 100 according to the present embodiment identifies the spread area of the disease and forecasts the infection route, and issues warning to the hospitals, the health centers, the pharmacies, etc., in the area where the disease may spread in the future. Therefore, since the hospitals, the health centers, the pharmacies, etc. can be prepared to deal with the disease promptly before the number of the patients infected with the disease increases.

As described above, according to the present invention, the incidence rate of a disease in each area can be computed, and the area where the disease will spread in the future is forecasted based on the electric medical charts.

Although the present invention has been described by way of an exemplary embodiment, it should be understood that those skilled in the art might make many changes and substitutions without departing from the spirit and the scope of the present invention. It is obvious from the definition of the appended claims that embodiments with such modifications also belong to the scope of the present invention.

What is claimed is:

1. A medical network server for receiving and transmitting information on electric medical charts from/to a plurality of medical institutions through a communication network, comprising:
a patient information storage section storing thereon the information on the electric medical charts including medical records of a plurality of patients diagnosed by a physician at each of the plurality of medical institutions, and location information indicating location of each of the medical institutions or addresses of patients;
an incidence rate computing section for computing incidence rate of a disease in each area based on the medical records and the location information of the plurality of patients;
a spread area identification section for identifying a first area, where the disease spreads, based on the incidence rate computed by said incidence rate computing section; and
a spread area forecast section for forecasting a second area, related to the first area with respect to the spread of the disease and in which the disease is supposed to spread in the future, based on a relationship between the first area and the second area.

2. The medical network server as claimed in claim 1, wherein said spread area forecast section forecasts the second area based on outbreak history information including the incidence rate of the disease in each of the areas during a plurality of time periods in the past.

3. The medical network server as claimed in claim 1, wherein said spread area forecast section forecasts the second area based on frequency of traffic between the first area and the second area.

4. The medical network server as claimed in claim 1, further comprising an outbreak forecast information storage section storing thereon the outbreak forecast information, wherein
said spread area forecast section forecasts the second area based on the outbreak forecast information stored on said outbreak forecast information storage section.

5 (ex. 3). The medical network server as claimed in claim 2, wherein said spread area forecast section further forecasts a time period when the disease will spread in the second area based on the outbreak history information.

6 (ex. 4). The medical network server as claimed in claim 1, further comprising a warning section for issuing warning to the medical institution located in the second area forecasted by said spread area forecast section in order to prompt the medical institution located in the second area forecasted by said spread area forecast section to prepare for the spread of the disease in the future.

7 (ex. 5). The medical network server as claimed in claim 6, further comprising a medical device indicating section for indicating medical devices required by the medical institution for diagnosis and treatment of the disease to the medical institution.

8 (ex. 6). The medical network server as claimed in claim 7, wherein said medical device indicating section further indicates quantity of the medical devices required by the medical institution for diagnosis and treatment of the disease to the medical institutions based on the incidence rate computed by said incidence rate computing section.

9 (ex. 7). A medical network system for relaying information on electric medical charts through a communication network, comprising:
a plurality of medical institutions storing therein the electric medical charts; and
a medical network server for receiving and transmitting the information on the electric medical charts from/to the plurality of medical institutions through the communication network, wherein
said medical network server comprises:
a patient information storage section storing thereon the information on the electric medical charts including medical records of a plurality of patients diagnosed by a physician at each of the plurality of medical institutions, and location information indicating location of each of the medical institutions or addresses of patients;
an incidence rate computing section for computing incidence rate of a disease in each area based on the medical records and the location information of the plurality of patients;
a spread area identification section for identifying a first area, where the disease spreads, based on the incidence rate computed by said incidence rate computing section; and
a spread area forecast section for forecasting a second area, related to the first area with respect to the spread of the disease and in which the disease is supposed to spread in the future, based on a relationship between the first area and the second area.

10. A method of receiving and transmitting information on electric medical charts from/to a plurality of medical institutions through a communication network, comprising steps of:
storing information on the electric medical charts including medical records of a plurality of patients diagnosed by a physician at each of the plurality of medical institutions, and location information indicating location of each of the medical institutions or addresses of patients;
computing incidence rate of a disease in each area based on the medical records and the location information of the plurality of patients;
identifying a first area, where the disease spreads, based on the incidence rate computed in said incidence rate computing step; and
forecasting a second area, related to the first area with respect to the spread of the disease and in which the disease is supposed to spread in the future, based on a relationship between the first area and the second area.

11. A computer readable medium storing thereon a program for causing a medical network server to receive and transmit information on electric medical charts from/to a plurality of medical institutions through a communication network, the program comprising modules configured to execute steps of:
storing information on the electric medical charts including medical records of a plurality of patients diagnosed by a physician at each of the plurality of medical institutions, and location information indicating location of each of the medical institutions or addresses of patients;
computing incidence rate of a disease in each area based on the medical records and the location information of the plurality of patients;
identifying a first area, where the disease spreads, based on the incidence rate computed in said incidence rate computing step; and
forecasting a second area, related to the first area with respect to the spread of the disease and in which the disease is supposed to spread in the future, based on a relationship between the first area and the second area.
